(19) United States
(12) Patent Application Publication
(10) Pub. No.: US 2015/0220893 A1
(43) Pub. Date: Aug. 6, 2015

(54) SOFTWARE MARKETING AND TRADE

(71) Applicants: Andrew Dale Jouffray, Liberty, UT (US); Matthew Paul Jouffray, Liberty, UT (US)

(72) Inventors: Andrew Dale Jouffray, Liberty, UT (US); Matthew Paul Jouffray, Liberty, UT (US)

(21) Appl. No.: 14/333,366

(22) Filed: Jul. 16, 2014

Related U.S. Application Data
(60) Provisional application No. 61/936,131, filed on Feb. 5, 2014.

(51) Int. Cl. G06Q 20/12

(52) U.S. Cl. CPC G06Q 20/1235; G06Q 20/127; G06Q 2220/18

(57) ABSTRACT

The disclosure extends to systems and methods for trading software over a computer network while compensating a selling trader and software publisher for the trades. The disclosure also extends to use of systems and methods that comprise a computer network of users and publishers of software who want to benefit from the trade and sales of new and used software products.

### CROSS-REFERENCE TO RELATED APPLICATIONS

This application claims the benefit of U.S. Provisional Application No. 61/936,131, filed Feb. 5, 2014, which is hereby incorporated by reference herein in its entirety, including but not limited to those portions that specifically appear hereinafter, the incorporation by reference being made with the following exception: In the event that any portion of any of the above-referenced provisional application is inconsistent with this application, this application supersedes said above-referenced provisional application.

### STATEMENT REGARDING FEDERALLY SPONSORED RESEARCH OR DEVELOPMENT

Not Applicable.

### BACKGROUND

The disclosure relates generally to software trade and sales. Also disclosed are methods and systems that are used to facilitate the legitimate and secure trading of software, and more particularly, but not necessarily entirely, to the trade of used or previously licensed software over a network.

In the current software marketplace it is often difficult for a current owner of software to fairly trade or sale that software, especially used software. Most often the purchaser of the software may be blocked by services and features associated with running the software. Such services and features are intended to prevent software piracy. Consequently, legitimate software usage is deterred by these restrictions in err. Because previously owned software is currently not transferrable due to the restrictions placed on the software by publishers or others, these previously owned software assets that could otherwise be sold are wasted. Even in homes, software based games, for example, often sit unused after a purchaser has played the game while other users would pay real value in money to play the same game on a second hand basis. Instead of being used, software often sits on hard drives and shelves underappreciated and undervalued.

In addition, software publishers are not eager to help remedy this shortcoming in the marketplace because they do not see additional revenue or value from second hand sales. Further, software publishers only see the possibility of providing technical and other support for additional users of its products without being compensated. What is needed is a system and method for facilitating previously owned or second hand software trade, while compensating the software publisher for its continued support of older software products. The present disclosure addresses this current deficiency in the marketplace by providing systems and methods for facilitating previously owned or second hand software trade, while compensating the software publisher for its continued support of older software products.

The features and advantages of the disclosure to remedy these issues will be set forth in the description that follows, and in part will be apparent from the description, or may be learned by the practice of the disclosure without undue experimentation. The features and advantages of the disclosure may be realized and obtained by means of the instruments and combinations particularly pointed out herein.

### SUMMARY OF THE DISCLOSURE

An implementation of the disclosure may comprise a use of a system that comprises a computer network of users and publishers of software who want to benefit from the trade and sales of new and used software products.

An implementation of the disclosure may comprise a method for software trading over a computer network comprising identifying a selling trader and a buying trader that may be connected over the computer network; receiving real money from the buying trader; compensating the selling trader with value tokens in exchange for access to the software previously owned; providing access for a download of the software from a publisher of the software to the trader in exchange for value tokens; providing a key corresponding to the download for accessing the software; and wherein the software publisher may be compensated a portion of the software's total value in real money each time the software is traded between traders over the computer network.

An implementation of the disclosure may comprise a method for software trading over a computer network comprising providing a forum over the computer network for trading keys among a plurality of traders connected to the computer network; identifying a selling trader and a buying trader that are connected over the computer network; receiving real money from the buying trader; compensating the selling trader with value tokens in exchange for access to the software previously owned; providing access for a download of the software from a publisher of the software to the trader in exchange for value tokens; providing a key corresponding to the download for accessing the software; wherein the software publisher is compensated a portion of the software's total value in real money each time the software is traded between traders over the computer network.

An implementation of the disclosure may comprise a method for software trading over a computer network comprising providing a forum over the computer network for trading keys among a plurality of traders connected to the computer network; identifying a selling trader and a buying trader that are connected over the computer network; receiving real money from the buying trader; compensating the selling trader with value tokens in exchange for access to the software previously owned; providing access for a download of the software from a publisher of the software to the trader in exchange for value tokens; providing a key corresponding to the download for accessing the software; wherein the software publisher is compensated a portion of the software's total value in real money each time the software is traded between traders over the computer network; and providing publisher access to the network with administrator rights to control the trading of software produced by said publisher.

An implementation of the disclosure may comprise a method for software trading over a computer network comprising identifying a selling software title and a buying trader that may be connected over the computer network; receiving real money from the buying trader; providing access for a download of the software title from a publisher of the software to the buying trader; providing a key corresponding to the download for accessing the software; wherein the software publisher may be compensated a portion of the software's total value in real money each time the software is traded between traders over the computer network after an initial purchase.

### BRIEF DESCRIPTION OF THE DRAWINGS

The features and advantages of the disclosure will become apparent from a consideration of the subsequent detailed description presented in connection with the accompanying drawings in which:

FIG. 1 illustrates an implementation of a method for the trade of software in accordance with the teachings and principles of the disclosure;

FIG. 2 is an illustration of a system for trading software in accordance with the teachings and principles of the disclosure;

FIG. 3 illustrates a schematic representation of computer hardware and protocols that enable the various implementations discussed herein in accordance with the principles and teachings of the disclosure;

FIG. 4 illustrates an implementation of a method for the trade of software in accordance with the teachings and principles of the disclosure;

FIG. 5 illustrates a schematic of a graphical user interface (GUI) that may be provided to users of a method for trading software over a computer network in accordance with the teachings and principles of the disclosure;

FIG. 6 illustrates an implementation of a method and system for trading software wherein a software publisher may control the trade and the use of the software by determining limits that are received through an exemplary graphical user interface (GUI) in accordance with the teachings and principles of the disclosure; and

FIG. 7 illustrates a schematic of a graphical user interface (GUI) that may be provided to allow a publisher direct access and control of the trade of its products over a network in accordance with the teachings and principles of the disclosure.

### DETAILED DESCRIPTION

For the purposes of promoting an understanding of the principles in accordance with the disclosure, reference will now be made to the implementations illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the devices, systems, methods and processes facilitating the trading and selling of new and/or previously owned software thereby facilitating an additional software marketplace are disclosed and described, it is to be understood that this disclosure is not limited to the particular embodiments, configurations, or process steps disclosed herein as such embodiments, configurations, or process steps may vary somewhat. It is also to be understood that the terminology employed herein is used for the purpose of describing particular implementations only and is not intended to be limiting since the scope of the disclosure will be limited only by the appended claims, if any, and equivalents thereof.

In describing and claiming the subject matter of the disclosure, the following terminology will be used in accordance with the definitions set out below.

It must be noted that, as used in this specification, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or ingredient not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

As used herein, the term “forum” is intended to denote a computing environment for a plurality of users that facilitates trade and/or communication between the users. For example, a forum may be accessed through a computer terminal, such that a user may trade and/or communicate over a network, and use software products.

As used herein, the term “trader” is intended to denote either a purchaser or seller of rights to software usage. For example, a trader may be a buyer or seller of rights to software usage, and in some instances a publisher of software may participate in a forum as a trader. Further, a trader may be both a buyer and seller of right to software usage.

As used herein, the term “token” is intended to convey a digital means for accounting for real currency or money issued by a government, governing body, or jurisdiction. For example, a system provider may exchange tokens for real currency or money at a certain exchange rate.

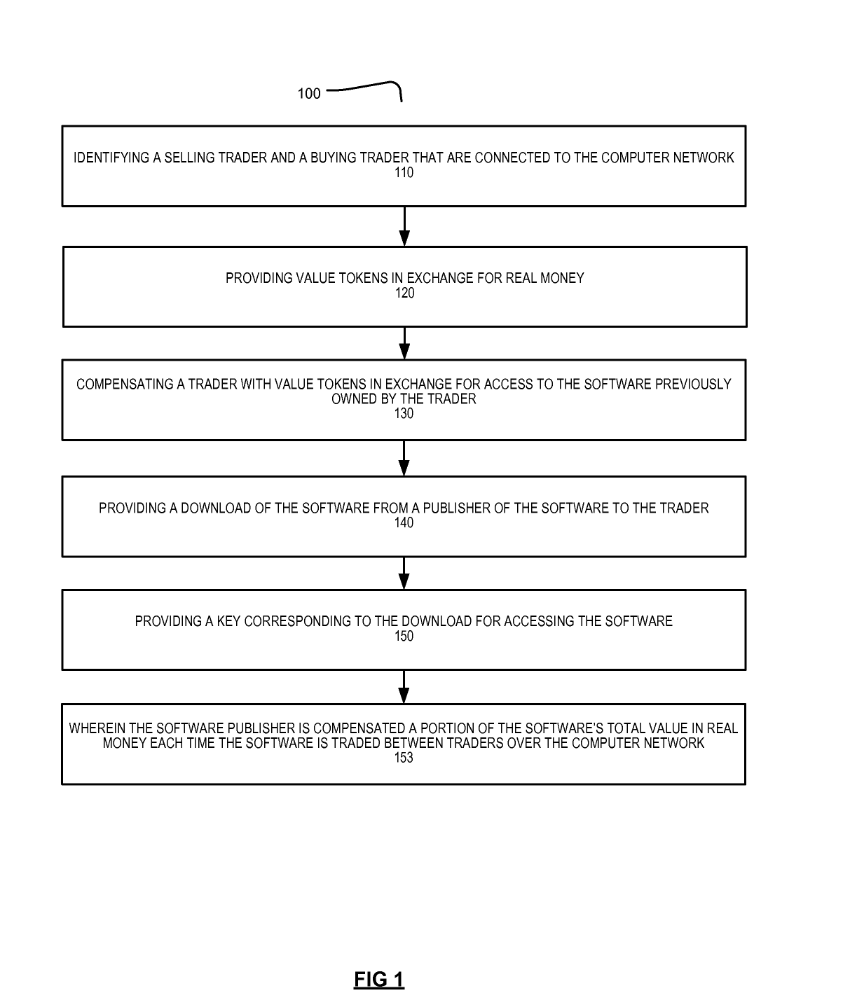

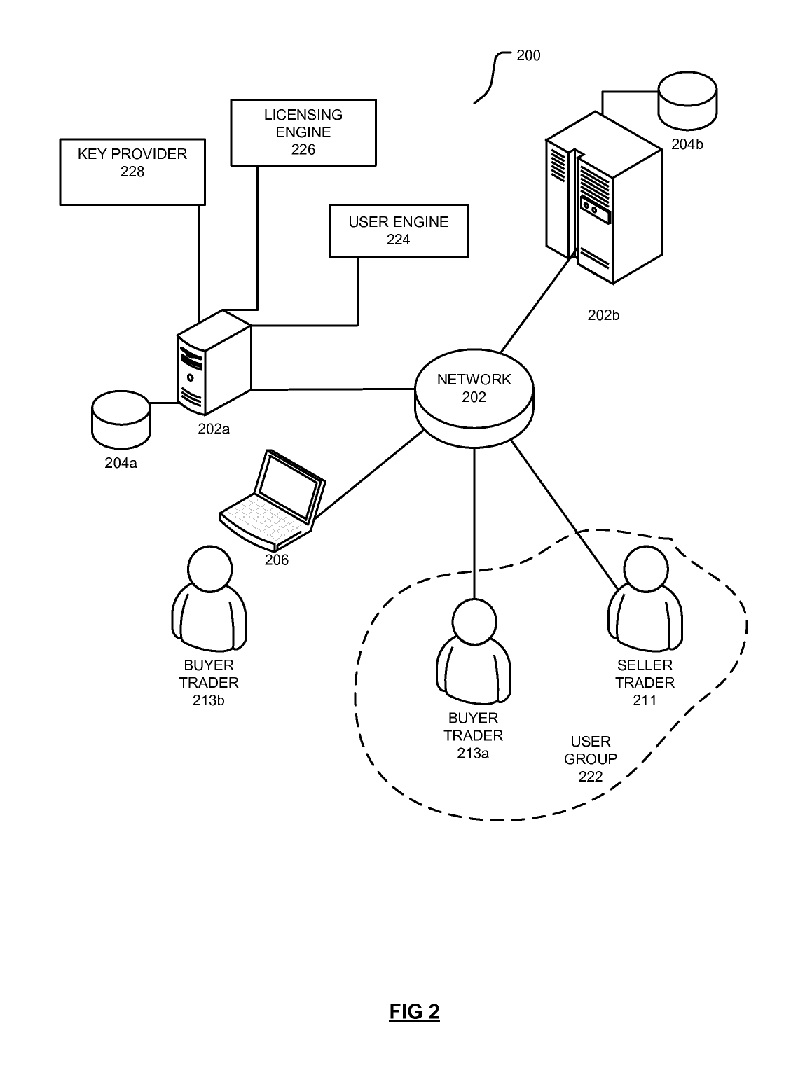

With reference primarily to FIG. 1, and secondarily to FIG. 2, an implementation disclosing the features of the disclosure will be generally discussed. FIG. 1 illustrates a method for software trading over a computer network that may comprise at 110 identifying a selling trader 211 and a buying trader 213a-213b that are connected over the computer network 202 at 110 of the method processes. As can be seen in FIG. 2, traders may be grouped into users groups 222 as illustrated by the dashed line surrounding buyer trader 213a and seller trader 211. As will be discussed in further detail below the user group 222 may be used to facilitate features and advantages of the trade marketplace and may be based on characteristics of the traders in the user group 222. In an implementation, software may be purchased by a user and included in a library that is maintained for that user. A library may comprise all of the titles of software that a user currently owns and may facilitate use of the software such that a user may access software through the library. Additionally, the library may facilitate the trade of the software such that a user may initiate trades through their own corresponding library or through the libraries that correspond to other traders. In an implementation, the method at 120 may comprise receiving real money from the buying trader 213a for use in trading software over the network 202. As in every successful marketplace type arrangement, at 130 the method may further comprise the processes of compensating the selling trader 211 with value tokens in exchange for access to new software or the software previously owned by the selling trader 211.

It should be noted that the term “access” is intended to denote any type of computer implemented allowance or license that allows the use of software that is legitimately protected by a computer implemented anti-piracy scheme. In the state of the art, common computer implemented anti-piracy schemes include the use of computer keys, serial numbers, and real-time security measures provided by publishers or third party security providers.

For example, a software user may possess the entirety of a software program on his/her computer, but may not be able to use it fully or legally without the means for properly accessing the program unless a serial number or key is provided. Accordingly, a successful system 200 and method 100 for trading software may facilitate the legitimate access of the software being traded. For example, a publisher of software may issue new keys for the traded software or may grant permission for the system 200 to issue new keys.

As used herein, the term “issue” or “issued” is intended to denote the creation, generation and/or delivery of a digital means for accessing software. For example, in an implementation a digital key may be issued that is generated using a key generator supplied by a publisher that corresponds to the previously owned or second hand nature of the traded software. In another implementation, an original key may be augmented by the system administrator with additional digital information such as a unique identifier corresponding to the trade without additional input from a corresponding publisher. It should be noted, that the issuance of keys may include any amount of publisher participation from full key generation to zero additional key generation for each instance that its software is traded.

At 140, the method 100 may include the process of providing access for a download of the software from a publisher of the software to the trader, and providing a key corresponding to the download for accessing the software at 150 (as discussed above). In an implementation, the compensation for the software may be demanded at the time of software download or when access is provided.

It should be noted that an implementation of the method may comprise the process of making an original sale to a user of first or second run software, wherein access to the software is initiated at the time of sale. It will be appreciated that the purchase or original sale of first or second run software may be made with tokens or with real money, which may be facilitated over the network.

At 160, the method 100 may comprise compensating the software publisher a portion of the software's total value in real money each time the software is traded between traders over the computer network. Compensation may be necessary to incentivize publishers to participate in previously owned or second hand trade of the publishers' software. In an implementation, the compensation may be provided to a publisher when a selling trader 211 sells the software or when a buying trader 213 buys the software in implementations where selling and buying can be done at different times.

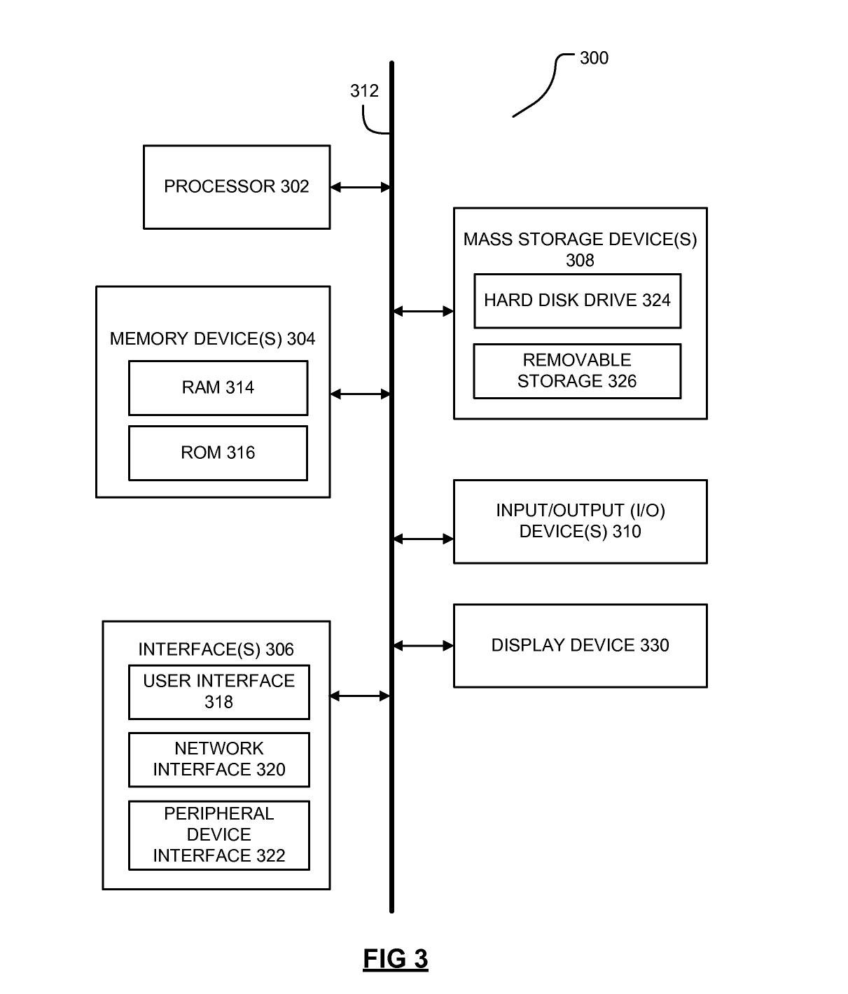

Referring now to FIG. 2, a computer system 200 for trading software over a network in accordance with the teachings and principles of the disclosure will be discussed. It will be appreciated that the method 100 of FIG. 1 may comprise processes performed in a computing environment 200 by a computing device 300 (of FIG. 3). Implementations of the disclosure may comprise or utilize a special purpose or general-purpose computer, including computer hardware, such as, for example, one or more processors and system memory, as discussed in greater detail below. Implementations that are within the scope of the disclosure also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code.

Although the subject matter has been described in language specific to structural features and/or methodological acts, it is to be understood that the subject matter defined in the appended claims, if any, is not necessarily limited to the described features or acts described above. Rather, the described features and acts are disclosed as example forms of implementing the disclosure.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the disclosure can also be used in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, or any suitable characteristic now known to those of ordinary skill in the field, or later discovered), service models (e.g., Software as a Service (SaaS), Platform as a Service (PaaS), Infrastructure as a Service (IaaS)), and deployment models (e.g., private cloud, community cloud, public cloud, hybrid cloud, or any suitable service type model now known to those of ordinary skill in the field, or later discovered). Databases and servers described with respect to the disclosure can be included in a cloud model.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and claims to refer to particular system components. As one skilled in the art will appreciate, components may be referred to by different names. This document does not intend to distinguish between components that differ in name, but not function.

FIG. 2 illustrates an example of a computing environment 200 suitable for implementing the methods disclosed herein. In some implementations, a server 202a provides access to a database 204a in data communication therewith may facilitate a database application. The database 204a may store information and may record information such as software data, key data, which may be provided by a key provider 228, and licensing data, which may be provided by a licensing engine 226. The database 204a may additionally store user/trader information by a user engine 224 contained in a plurality of records for defining a user group 222. The server 202a may provide access to the database 204a to users and groups 222 associated with a project. For example, the server 202a may implement a web server for receiving requests for data stored in the database 204a and formatting requested information into web pages that may be provided to users during a trade. The web server may additionally be operable to receive information and store the information in the database 204a and facilitate a shared group area 222.

A server 202b may be associated with a publisher or plurality of publishers providing software as discussed herein. The server 202b may be in data communication with a database 204b. In particular, information for scheduling and reporting may include a name, availability, preferences, description, categorization, event, document data, comments, number of times software is sold, software activity data, software trading data and the like. The server 202b may analyze this data as well as data retrieved from the database 204a in order to perform methods as described herein. An operator may access the server 202b by means of a workstation 206 that may be embodied as any general purpose computer, tablet computer, smart phone, or the like.

The server 202a and server 202b may communicate over a network 202 such as the Internet or some other local area network (LAN), wide area network (WAN), virtual private network (VPN), or other network. A user may access data and functionality provided by the servers 202a, 202b by means of a workstation in data communication with the network 202. The workstation may be embodied as a general purpose computer, tablet computer, smart phone or the like. For example, the workstation may host a web browser for requesting web pages, displaying web pages, and receiving user interaction with web pages, and performing other functionality of a web browser.

The workstation 206, servers 202a, 202b and databases 204a, 204b may have some or all of the attributes of a computing device and may operate a software trading marketplace application. It should be noted that the software marketplace application may be operated from any computing device with in the computing environment 200.

FIG. 3 illustrates a block diagram illustrating an example computing device 300. Computing device 300 may be used to perform various procedures, such as those discussed herein. Computing device 300 can function as a server, a client, or any other computing entity. Computing device 300 can perform various monitoring and receiving functions as discussed herein, and can execute one or more application programs, such as the application programs described herein. Computing device 300 can be any of a wide variety of computing devices, such as a desktop computer, a notebook computer, a server computer, a handheld computer, tablet computer and the like.

Computing device 300 includes one or more processor(s) 302, one or more memory device(s) 304, one or more interface(s) 306, one or more mass storage device(s) 308, one or more Input/Output (I/O) device(s) 310, and a display device 330 all of which are coupled to a bus 312. Processor(s) 302 include one or more processors or controllers that execute instructions stored in memory device(s) 304 and/or mass storage device(s) 308. Processor(s) 302 may also include various types of computer-readable media, such as cache memory.

Memory device(s) 304 include various computer-readable media, such as volatile memory (e.g., random access memory (RAM) 314) and/or nonvolatile memory (e.g., read-only memory (ROM) 316). Memory device(s) 304 may also include rewritable ROM, such as Flash memory.

Mass storage device(s) 308 include various computer readable media, such as magnetic tapes, magnetic disks, optical disks, solid-state memory (e.g., Flash memory), and so forth. As shown in FIG. 3, a particular mass storage device is a hard disk drive 324. Various drives may also be included in mass storage device(s) 308 to enable reading from and/or writing to the various computer readable media. Mass storage device(s) 308 include removable media 326 and/or non-removable media.

I/O device(s) 310 include various devices that allow data and/or other information to be input to or retrieved from computing device 300. Example I/O device(s) 310 include cursor control devices, keyboards, keypads, microphones, monitors or other display devices, speakers, printers, network interface cards, modems, lenses, CCDs or other image capture devices, and the like.

Display device 330 includes any type of device capable of displaying information to one or more users of computing device 300. Examples of display device 330 include a monitor, display terminal, video projection device, and the like.

Interface(s) 306 include various interfaces that allow computing device 300 to interact with other systems, devices, or computing environments. Example interface(s) 306 may include any number of different network interfaces 320, such as interfaces to local area networks (LANs), wide area networks (WANs), wireless networks, and the Internet. Other interface(s) include user interface 318 and peripheral device interface 322. The interface(s) 306 may also include one or more user interface elements 318. The interface(s) 306 may also include one or more peripheral interfaces such as interfaces for printers, pointing devices (mice, track pad, or any suitable user interface now known to those of ordinary skill in the field, or later discovered), keyboards, and the like.

Bus 312 allows processor(s) 302, memory device(s) 304, interface(s) 306, mass storage device(s) 308, and I/O device(s) 310 to communicate with one another, as well as other devices or components coupled to bus 312. Bus 312 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 300, and are executed by processor(s) 302. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

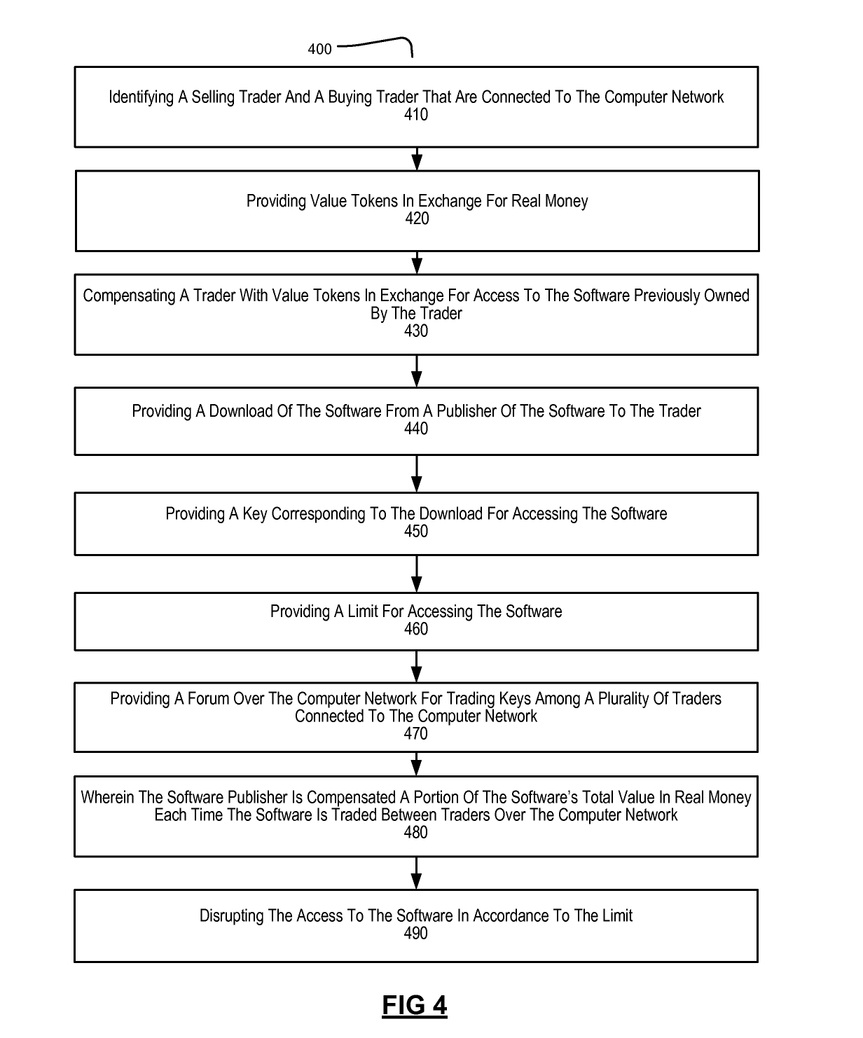

Referring now primarily to FIG. 4, an implementation of a method for trading software will be discussed, wherein the trade and the use of the software is limited by a limiting factor. Method 400 may comprise at 410 identifying a selling trader 211 (of FIG. 2) and a buying trader 213a-213b that are connected over the computer network 202 of the method processes. As can be seen in the figure, traders may be grouped into users groups 222 as illustrated by the dashed line in FIG. 2. The user group 222 may be used to facilitate features and advantages of the trade marketplace and may be based on characteristics of the traders in the user group 222. In an implementation, the method at 420 may comprise receiving real money from the buying trader 213a for use in trading software over the network 202. As in every successful marketplace type arrangement, at 430 the method may further comprise the processes of compensating the selling trader 211 with value tokens in exchange for access to the software previously owned by the selling trader 211.

At 440, the method 400 may include the process of providing access for a download of the software from a publisher of the software to the trader. The method 400 may further include providing a key corresponding to the download for accessing the software at 450 (see access to software as discussed above). In an implementation, the compensation for the software may be demanded at the time of software download or when access is provided.

At 460, a limiting factor may be received by the system and recorded to memory. The limiting factor may be determined by a publisher or system administrator over the network. In an implementation, a limiting factor may be a time period. The limiting factor in that implementation may limit how a software title may be traded during a specified time period. For example, a publisher may wish to limit the trading of new software games for six months after its original release date in order to maximize full purchase price sales during the time period that the game is the most popular. In another example, a publisher may only want its software sold a maximum number of three times. In such a situation, the third purchaser would not be allowed to sell the software.

In an implementation a limiting factor may be a count type limit, such that a software program may only be traded a certain number of times, or may only be accessed a certain number of times. For example, a publisher may wish that certain software titles only be traded three times on the previously owned or second hand market.

In an implementation, a limiting factor may correspond to the user and/or user group that are trading the software title. For example, certain users may be given preferential treatment regarding limitations to trade as an incentive for participation in the trading system. Additionally, in an implementation users may be designated as super-users by meeting certain requirements of participation within the network. A super-user may earn preferential treatment and may be incentivized with specific compensation portions and promotions.

It should be noted that any combination of the limitations to trade is considered to fall within the scope of the disclosure, such that the system may be as simple or complex as desired for individual software titles and types.

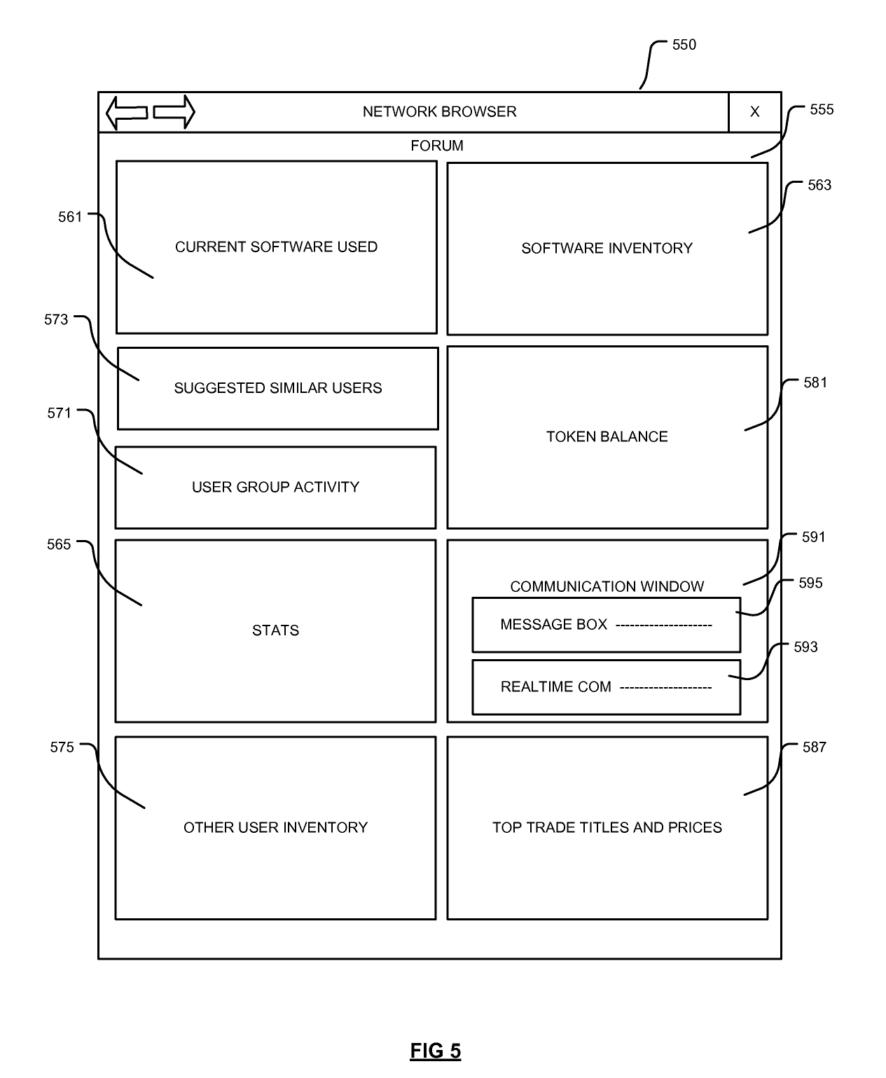

At 470, an implementation of the method may further comprise providing a forum for facilitating the trading of software. A forum may be a computing environment for a plurality of users that facilitates trade and communication between the users. For example, a forum may be accessed through a computer terminal such that a user may trade, communicate and use software products. In an implementation, the forum may facilitate the trading of software, data, and/or keys for accessing the software. The forum may be presented over the network through a graphical user interface 555 as illustrated in FIG. 5. The graphical user interface 555 may be used to convey information to a user and receive information from a user over the computer network. The graphical user interface 555 may be used to facilitate communication between users in real time or though delayed email services.

At 480, the method 400 may include compensating the software publisher a portion of the software's total value in real money each time the software is traded between traders over the computer network. In order to incentivize publishers to participate in previously owned or second hand trade of their software compensation may be necessary. In an implementation, a publisher may be compensated equally each time the software is traded. In an implementation, a publisher may be compensated differently depending on the characteristics of the trade. For example, a publisher may be compensated a first portion of the trade price for first run software and a second portion of the trade price for second hand traded software transactions. In an implementation, the compensation may correlate with limitations imposed on the trading of the software. For example, the software may be limited to being traded three times and the publisher may be compensated a portion of the total value of the software at each trade (one third each time). In an implementation, when a software title is traded the publisher gets a third of the purchase value, the seller gets a third of the purchase value, and the system administration gets a third of the purchase value.

In an implementation, the portion of the software's total value may be 30% of a real money purchase price for the software. In an implementation, the publisher may be compensated a first portion for new software access and compensated a second portion for traded software access. In an implementation, the first portion provided to the publisher is greater than the second portion. In an implementation, the trader may be compensated 70% of a real money value of the software in value tokens. In an implementation, the trader may be compensated 70% of a real money value of the software in real money.

In an implementation, the access to the software may be resold to a user. In an exemplary scenario, the software may be resold and seventy percent of the purchase price may be provided to the selling trader of the software, whether in real money or in value tokens, while five percent may be provided to the server provider and the final twenty-five percent may be provided to the studio or publisher. In another exemplary scenario, seventy percent of the purchase price may be provided to the selling trader of the software, whether in real money or in value tokens, while the other thirty percent may be provided to the studio or publisher. It will be appreciated that the percentages provided above are merely exemplary and are not be limiting of the scope of the disclosure.

It will be appreciated that the disclosure contemplates trading the software any number of times based on a publisher's input or limitation on such trades or sales. The publisher may control the limiting factor of the software trade, such as the number of times the software is traded. It should be noted that in an implementation a seller may only ever be compensated with tokens so as to encourage future use of the system.

At 490, the method 400 may further comprise the process of disrupting access to the software in accordance to a predetermined limit. In order to prevent the simultaneous use of the same software copy, the access and use of the software may be suspended for the selling trader. The disruption may be facilitated through any currently known process or processes yet to be developed. In an implementation, a user may be notified of the disruption through a forum by way of a graphical user interface. In an implementation, access may be disrupted by changing the key that is used to access and use the software.

In an implementation that includes library functionality, a user's access to sold software can be disrupted by removing the software title from the library. In an implementation, the software title may be greyed out or otherwise designated as not accessible. Access to the library may be controlled or access to the games within the library may be denied by the system provider, the publisher, or some combination thereof.

FIG. 5 illustrates a schematic illustration of a graphical user interface (GUI) 555 that may be provided to users of a method for trading software over a computer network. As can be seen in the figure, a browser page 550 may graphically convey forum information to a user. The forum GUI 555 may comprise a current-software-in-use area 561 dedicated to displaying software of a user that is currently being run by a user. The forum GUI 555 may comprise a software inventory and library area 563 that is dedicated to conveying information regarding the software owned, accessed, or controlled by the user on the forum. In an implementation, the software inventory and library area 563 may operate as a portal through which a user may initiate use of software or initiate the trade of software.

In an implementation, the forum GUI 555 may comprise a stats area 565 dedicated to displaying user stats. For example, in an implementation wherein the software is gaming software, the stats area 565 may convey historical gaming statistics that represent the user's gaming achievements and awards. However, it will be appreciated that other stats for other types of software may also be displayed on the GUI 555 without departing from the scope of the disclosure.

It should be noted that certain types of software lend itself to social behaviors. Accordingly, the forum GUI 555 may comprise a social networking area, such as a user-group-activity-area 571 and suggested-similar-users area 573 for increasing user to user interaction or contact. The user-group-activity-area 571 may be dedicated to conveying information about other users in a user group. The suggested-similar-users area 573 may convey information regarding other users or products that may be of interest to the user based on discovered similarities in various predetermined characteristics. In certain implementations, characteristic similarities may be based on user activities over the network and/user inventories as tracked by the system. An implementation of the method may further comprise suggesting social connections to a user and then receiving selections from a user regarding the suggestions that are desired by the user. Additionally, an area of the forum GUI 555 may be dedicated to showing the inventory of other users in an other-user-inventory area 575.

In an implementation, a user group area may comprise notifications regarding software that is being offered for sale by other users in the user group.

Remaining consistent with facilitating software trade, a token balance area 581 may be included. The token balance area may be used to show other data such as historical data, inventory value data, sold inventory data and the like.

An implementation may further comprise a top trade area 587 that displays software market information regarding price and desirability of software titles. Such market information may be provided in real time in at least one implementation.

In an implementation, a forum GUI 555 may comprise a communication area or window 591 that is designed to facilitate communication between forum users. The communication area 595 may comprise a real time message area 593 or a message or mailbox area 595.

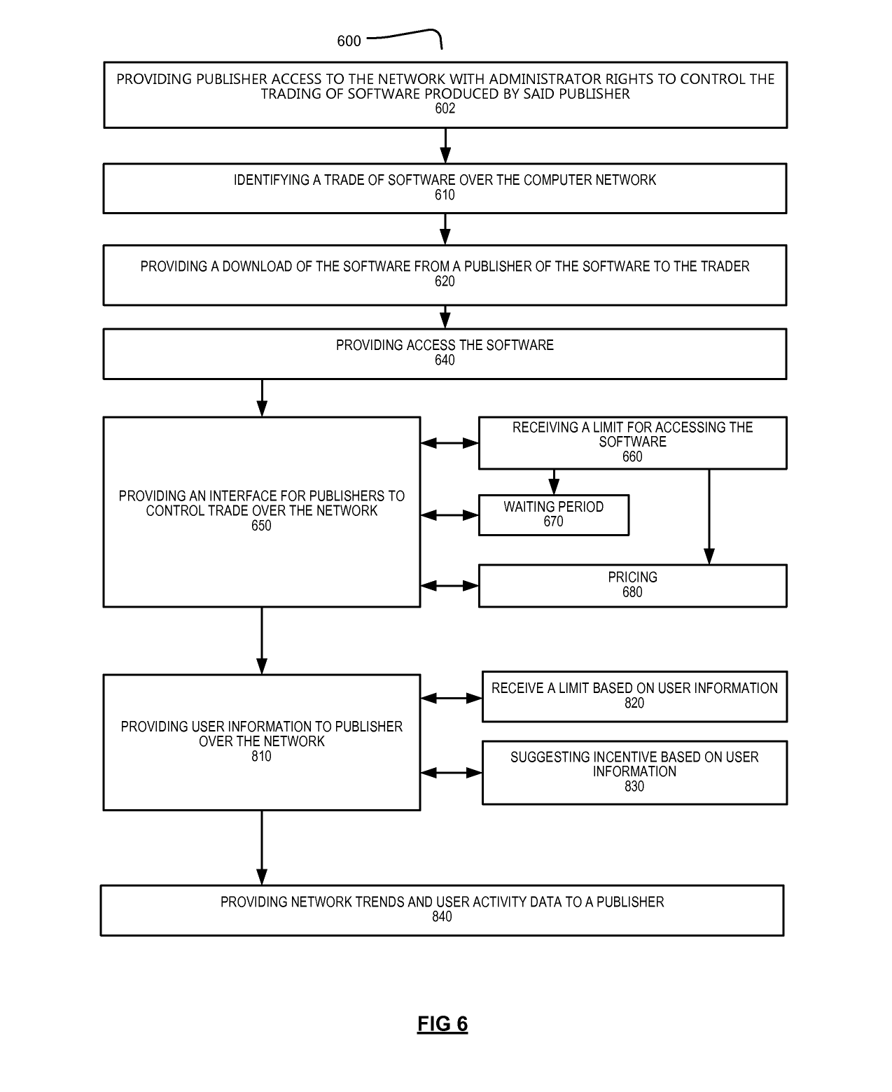

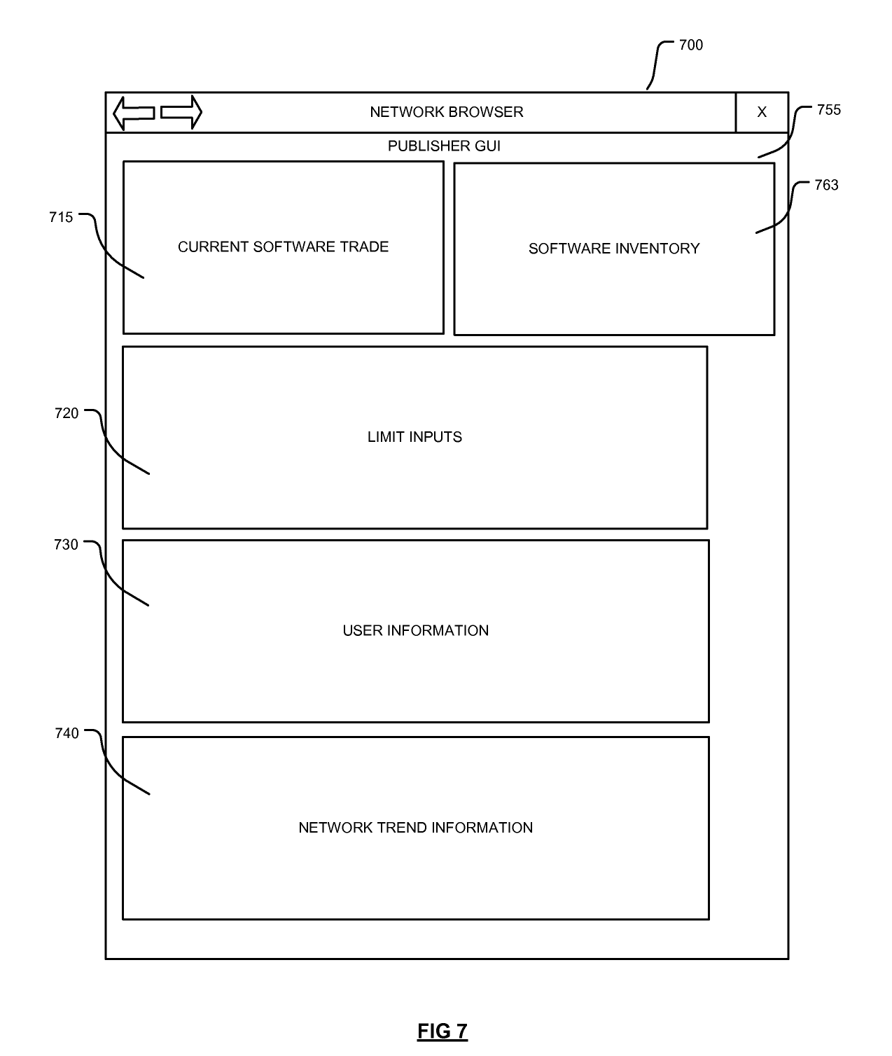

Referring now primarily to FIG. 6, and secondarily to FIG. 7, an implementation of a method and system for trading software wherein a publisher may control the trade and the use of the software by determining limits that are received through an exemplary graphical user interface (GUI) will be discussed. Method 600 may comprise at 602 providing a publisher access to the network with administrator rights to control the trading of software produced by said publisher. The method may also comprise identifying a trade of software over a computer network at 610 as illustrated in a current software trade area 715 of the publisher GUI 755.

At 620, a download of the software may be facilitated between the publisher and the trader over the network. At 640, the method 600 may include the process of providing access to the software. For example, the process of providing access to the software may include providing a download of the software from a publisher of the software to the trader, and providing a key corresponding to the download for accessing and using the software.

At 660, a limit or limiting factor may be received by the system through a publisher GUI provided at 650. As illustrated in FIG. 7, the publisher GUI may comprise a limit input area 720 allowing a publisher direct access and control of the trade of its products over the network. In an implementation, a limiting factor may be a time period as received at 670, and may limit how a software title may be traded during the time period. For example, a publisher may wish to limit the trading of new games for six months, or some other time increment, after its original release in order to maximize full purchase price sales during the period that the game is the most popular. In an implementation, the limiting factor may be a price adjustment determined by the publisher.

In an implementation a limiting factor may be a count type limit such that a software program may only be traded a certain number of times, or may only be accessed a certain number of times. In an implementation a limiting factor may correspond to the user and/or user group that are trading the software title at 820 based on user information provided to a publisher at 810 and illustrated in the user information area 730 of the publisher GUI 700. For example, a publisher may wish to reward certain users for loyalty and for their promotion of the publisher's products. Accordingly, a publisher may be able to adjust trade limits based on such factors through the publisher GUI at 820. In an implementation, incentive suggestions may be provided to the publisher relative to trends and the actions of certain users at 830.

In an implementation, trading information gathered from network activity and trends may be provided to a publisher at 840 through the publisher GUI 700 in the network trend area 740. The trend date may be generated into a report and presented to a publisher over the network.

In an implementation, a publisher may be provided with sales information derived from the trading and use of relevant software titles. Additionally, the publisher may be provided with the trading information such as average prices at the first, second, third, and fourth resells or trading of the software titles. In an implementation, the information provided may comprise average time played. In an implementation, the information provided may comprise average time played for each software title before being traded or resold.

In an implementation, a forum may be provided to users where such users may be provided with the opportunity to grade a software title, such as a game, or otherwise discuss the features of the software, such as the game, with other users. In an implementation, the grading information may then be provided to the publishers along with other statistical analysis obtained from information provided through the forum. In an implementation, information may be provided to publishers relating to the types of games or software titles that are being resold and at the resell price, such as at a high resell price for a specific software title or a low resell price for another software title, to thereby better understand the purchasing patterns and desires of a particular targeted gaming population or segment of the larger gaming population.

In an implementation, a forum may include an “Exchange” modeled on a “Stock Exchange.” For example, the forum may include an exchange where new or used software or software titles may be purchased and sold to bidders.

An implementation of a method for software trading over a computer network may comprise identifying a selling software title and a buying trader that are connected over the computer network. An implementation may further comprise receiving real money from the buying trader. In an implementation, the initial purchase is made in real money. An implementation may further comprise providing access for a download of the software title from a publisher of the software to the buying trader. An implementation may further comprise providing a key corresponding to the download for accessing the software. It will be appreciated that the software publisher may be compensated a portion of the software's total value in real money each time the software is traded between traders over the computer network after an initial purchase is made.

An implementation may further comprise providing publisher access to the network with administrator rights to control the trading of software produced by the publisher. An implementation may further comprise providing a forum over the computer network for trading keys among a plurality of traders connected to the computer network.

An implementation may further comprise exchanging real money for tokens. In an implementation, exchanging real money for tokens may be limited to a designated class of user. For example, super-users may be provided with rights that are above and beyond what the typical user may be provided with, such as the right to exchange real money for additional tokens, such that super-users may be able to have additional flexibility with respect to their accounts.

An implementation may further comprise providing statistics to publishers regarding software used and traded over the network. It will be appreciated that the statistics may comprise various types of information, including original sales information, used or reselling information, average time played, average time played by a user before reselling the software title, information regarding grade of the software title, as well as user and trader information. These statistics may be shared with the publisher or other third parties interested in using such information to assist them in creating new software titles, analyzing features of a software title that sold or performed well, in addition to other statistical analysis that may be gleaned from such information and data.

In the foregoing Detailed Description, various features of the disclosure are grouped together in a single implementation for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed implementation. Thus, the following claims are hereby incorporated into this Detailed Description of the Disclosure by this reference, with each claim standing on its own as a separate implementation of the disclosure.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A method for software trading over a computer network comprising:
identifying a selling trader and a buying trader that are connected over the computer network;
receiving real money from the buying trader;
compensating the selling trader with value tokens in exchange for access to the software previously owned;
providing access for a download of the software from a publisher of the software to the trader in exchange for value tokens;
providing a key corresponding to the download for accessing the software; and
wherein the software publisher is compensated a portion of the software's total value in real money each time the software is traded between traders over the computer network.

2. The method of claim 1, further comprising providing a limit for accessing the software.

3. The method of claim 2, further comprising stopping access to the software in accordance to the limit.

4. The method of claim 2, wherein the limit is a time period.

5. The method of claim 2, wherein the limit is a count.

6. The method of claim 5, wherein the count is the number of times that the software can be traded.

7. The method of claim 6, wherein the number of times that the software can be traded is three.

8. The method of claim 2, wherein the limit corresponds to a user group.

9. The method of claim 2, wherein the limit is predetermined by a software publisher.

10. The method of claim 1, wherein the portion of the software's total value is a 30% of a real money purchase price for the software.

11. The method of claim 1, wherein the publisher is compensated a first portion for new software access and compensated a second portion for traded software access.

12. The method of claim 11, wherein the first portion is greater than the second portion.

13. The method of claim 1, wherein the trader is compensated 70% of the real money value of the software in value tokens.

14. The method of claim 1, further providing notice over the computer network that access to the software has been disrupted.

15. The method of claim 1, wherein the key provided comprises a unique identifier that corresponds to the trade over the network.

16. The method of claim 1, further comprising providing incentives for participating on the computer network.

17. The method of claim 1, further comprising designating one of a plurality of users as a super-user.

18. The method of claim 17, wherein the super-user is compensated with incentives corresponding to the super-user designations.

19. A method for software trading over a computer network comprising:
identifying a selling software title and a buying trader that are connected over the computer network;
receiving real money from the buying trader;
providing access for a download of the software title from a publisher of the software to the buying trader;
providing a key corresponding to the download for accessing the software;
wherein the software publisher is compensated a portion of the software's total value in real money each time the software is traded between traders over the computer network after an initial purchase.

20. The method of claim 19, wherein the method further comprises providing publisher access to the network with administrator rights to control the trading of software produced by said publisher.

21. The method of claim 19, wherein the method further comprises providing a forum over the computer network for trading keys among a plurality of traders connected to the computer network.

22. The method of claim 19, wherein the initial purchase is made in real money.

23. The method of claim 19, wherein the method further comprises exchanging real money for tokens.

24. The method of claim 23, wherein exchanging real money for tokens is limited to a designated class of user.

25. The method of claim 19, wherein the method further comprises providing statistics to publishers regarding software used and traded over the network.

26. The method of claim 25, wherein the statistics comprise sales information.

27. The method of claim 25, wherein the statistics comprise reselling information.

28. The method of claim 25, wherein the statistics comprise average time played.

29. The method of claim 25, wherein the statistics comprise information regarding grade of the game.

30. The method of claim 25, wherein the statistics comprise user and trader information.
